(19) United States
(12) Patent Application Publication
(10) Pub. No.: US 2017/0139128 A1
(43) Pub. Date: May 18, 2017

(54) PIXEL OUTPUT COUPLER FOR A LASER DISPLAY SYSTEM

(71) Applicant: Changhong Research Labs, Inc., Santa Clara, CA (US)

(72) Inventor: Greg Miller, Sunnyvale, CA (US)

(21) Appl. No.: 14/959,709

(22) Filed: Dec. 4, 2015

Related U.S. Application Data
(60) Provisional application No. 62/255,901, filed on Nov. 16, 2015.
(60) Provisional application No. 62/255,910, filed on Nov. 16, 2015.
(60) Provisional application No. 62/255,942, filed on Nov. 16, 2015.

(51) Int. Cl. G02B 6/02; G02B 5/02; G02F 1/1335

(52) U.S. Cl. CPC G02B 6/02; G02F 1/133504; G02B 5/0252; G02F 1/133305

(57) ABSTRACT

A pixel structure of a display device is provided. The pixel structure can include a substrate and a waveguide coupled to the substrate. The waveguide can include a first cladding layer disposed over the substrate, a core layer disposed over the first cladding layer, and a second cladding layer disposed over the core layer. The pixel structure can further includes a first conductive layer disposed over the waveguide, an electro-optic polymer (EOP) layer disposed over the first conductive layer, a second conductive layer disposed over the EOP layer, and a controller operable to adjust a bias voltage applied between the first conductive layer and the second conductive layer. The refractive index of the EOP layer can be varied in response to the bias voltage, thereby adjusting an amount of light coupled into the EOP layer from the waveguide.

### CROSS-REFERENCES TO RELATED APPLICATIONS

This application claims priority to U.S. Provisional Patent Application Nos. 62/255,901, filed Nov. 16, 2015, entitled “WAVEGUIDE STRUCTURE FOR LASER DISPLAY SYSTEM,” 62/255,910, filed Nov. 16, 2015, entitled “METHOD FOR CONTROL OF LASER DISPLAY SYSTEM,” and 62/255,942, filed Nov. 16, 2015, entitled “PIXEL OUTPUT COUPLER FOR A LASER DISPLAY SYSTEM.” The disclosures of these applications are hereby incorporated by reference for all purposes.

The following regular U.S. patent applications (including this one) are being filed concurrently, and the entire disclosure of the other applications are incorporated by reference into this application for all purposes:
Application Ser. No. ______, filed Dec. 4, 2015, entitled “WAVEGUIDE STRUCTURE FOR LASER DISPLAY SYSTEM” (Attorney Docket No. 098264-0966332 (000410US);
Application Ser. No. ______, filed Dec. 4, 2015, entitled “METHOD FOR CONTROL OF LASER DISPLAY SYSTEM” (Attorney Docket No. 098264-0966333 (000510US); and
Application Ser. No. ______, filed Dec. 4, 2015, entitled “PIXEL OUTPUT COUPLER FOR A LASER DISPLAY SYSTEM” (Attorney Docket No. 098264-0966334 (000610US).

### BACKGROUND OF THE INVENTION

Various image display technologies have been developed to improve images displayed by electronic devices such as televisions, computer monitors, and portable electronic devices. Several common display technologies include Liquid Crystal Display (LCD), Plasma, Organic Light Emitting Diodes (OLEDs), and multiple variants of these and other technologies. LCD technology has grown to become the most common display technology in use by electronic devices. However, several drawbacks exist with existing display technologies, thus there is need for improvement.

### SUMMARY OF THE INVENTION

This disclosure describes various embodiments that relate to display assemblies suitable for use in electronic display devices.

A waveguide structure is disclosed. The wave structure can be configured to distribute multiple wavelengths of light emitted by a variable intensity light source of a display unit. The waveguide structure can include the following: a waveguide bus configured to receive light from the variable intensity light source; and waveguide branches, each of the waveguide branches can include: a waveguide; a valve configured to convey a varying amount of the light received by the waveguide bus into the waveguide, the amount of light conveyed by the valve varying differently than the other valves of the waveguide structure, and multiple pixels distributed along the waveguide, each pixel configured to vary an amount of light coupled from the waveguide to each pixel.

A display unit is disclosed that can include the following: a display housing; a variable intensity light source disposed within the display housing; and a waveguide structure optically coupled to the variable intensity light source, the waveguide structure including waveguide branches and a waveguide bus configured to deliver light from the variable intensity light source to each of the waveguide branches. Each of the waveguide branches can include the following: a waveguide; multiple pixels distributed along the waveguide, each pixel including a subpixel configured to vary an amount of light delivered from the waveguide and through the pixel; and a valve configured to convey a portion of the light in the waveguide bus into the waveguide. The display unit can also include a controller configured to receive a video input signal and to send command signals to each of the valves and to each of the subpixels to independently modulate an amount of light allowed to pass through each valve and subpixel in accordance with and in response to the video input signal.

A display assembly is disclosed. The display assembly is suitable for use in a display device. The display assembly can include the following: a variable intensity light source; a controller configured to receive an input signal; and a multi-layer substrate. The multi-layer substrate can include an array of pixels; and a waveguide structure configured to distribute light from the variable intensity light source to each pixel of the array of pixels in accordance with the input signal.

In some examples, disclosed are methods, systems, and apparatus for controlling a display having a plurality of pixels. The methods can include receiving, by a controller, information related to an image to be displayed on the display. The methods can further include determining, using the controller and the information, a total amount of light associated with the image and a subset pixel intensity associated with a subset of the plurality of pixels. The methods can additionally include emitting an optical beam from a variable intensity light source and into a waveguide, an intensity of the optical beam being determined by the controller as a function of the total amount of light. The methods can also include directing, using the controller and the subset pixel intensity associated with the subset of the plurality of pixels, a valve coupled to the waveguide to propagate at least a portion of the optical beam to the subset of the plurality of pixels.

The methods can include determining, using a controller, a light budget for an image to be displayed by the display and controlling, using the controller, an amount of light output by each of the plurality of pixels. The display can be configured such that emitting a first portion of the light budget from a first pixel of the plurality of pixels reduces a remaining amount of the light budget available for remaining pixels of the plurality of pixels.

The methods can include determining, using a controller, a first amount of light associated with a first pixel of the plurality of pixels to display at least a portion of an image using the display, the first amount of light being less than a total amount of light capable of being emitted by the first pixel, the first pixel coupled to the waveguide. The methods can also include controlling, using the controller, a second amount of light output by a second pixel of the plurality of pixels, the second pixel coupled to the waveguide. The display can be configured such that the remaining light of the total amount of light capable of being emitted by the first pixel is retained and available to be emitted by the second pixel.

Disclosed features of an apparatus can include a controller. The controller can be configured to receive information related to an image to be displayed on the display, determine a total amount of light associated with the image, and determine a pixel intensity associated with each pixel of a subset of the plurality of pixels. The apparatus can further include a variable intensity light source configured to emit an optical beam having an intensity determined by the controller as a function of the total amount of light. The apparatus can also include a waveguide configured to propagate the optical beam. The apparatus can include a valve coupled to the waveguide and the controller, wherein the valve is configured to direct at least a portion of the optical beam to the subset of the plurality of pixels based, at least in part, on each pixel intensity.

According to an embodiment of the present invention, a pixel structure of a display device can include a substrate and a waveguide coupled to the substrate. The waveguide can include a first cladding layer disposed over the substrate, a core layer disposed over the first cladding layer, and a second cladding layer disposed over the core layer. The pixel structure further can include a first conductive layer disposed over the waveguide, an electro-optic polymer (EOP) layer disposed over the first conductive layer, a second conductive layer disposed over the EOP layer, and a controller operable to adjust a bias voltage applied between the first conductive layer and the second conductive layer. The refractive index of the EOP layer can be varied in response to the bias voltage, thereby adjusting an amount of light coupled into the EOP layer from the waveguide.

According to another embodiment of the present invention, a method of operating a pixel of a display device can include providing a pixel structure. The pixel structure can include a substrate and a waveguide coupled to the substrate. The waveguide can include a first cladding layer disposed over the substrate, a core layer disposed over the first cladding layer, and a second cladding layer disposed over the core layer. The pixel structure can further include a first conductive layer disposed over the waveguide, an electro-optic polymer (EOP) layer disposed over the first conductive layer, and a second conductive layer disposed over the EOP layer. The method can further include applying a bias voltage between the first conductive layer and the second conductive layer, propagating light in the waveguide, and varying the bias voltage to adjust an amount of light coupled from the waveguide into the EOP layer.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a rear view of an integrated waveguide structure of a display assembly;

FIG. 2 shows an exemplary embodiment of a variable intensity light source and a controller;

FIG. 3A shows a close up view of a portion of the display assembly depicted in FIG. 1;

FIG. 3B shows a cross-sectional view the display assembly depicted in FIG. 1 in accordance with section line A-A depicted in FIG. 3A;

FIG. 3C shows a cross-sectional view of the display assembly depicted in FIG. 1 in accordance with section line B-B depicted in FIG. 3A;

FIGS. 4A-4D show alternative waveguide structures suitable for use with a display assembly;

FIG. 5A shows a front view of a portion of the display assembly and corresponding subpixels, valves, and control lines;

FIG. 5B shows a front view of a portion of an alternate embodiment of a display assembly and corresponding subpixels, valves, and control lines;

FIG. 6 shows an exemplary display control configuration;

FIG. 7 shows an exemplary image that can be displayed on a display in accordance with the described embodiments;

FIG. 8 shows an exemplary flowchart for the control of a display;

FIG. 9 illustrates a partial schematic top view of a display device according to an embodiment of the invention.

FIG. 10 illustrates a schematic cross sectional view of a pixel structure of a display device according to an embodiment of the invention.

FIG. 11 illustrates a schematic cross sectional view of a pixel structure of a display device according to another embodiment of the invention.

FIG. 12 illustrates a schematic cross sectional view of a pixel structure of a display device according to an additional embodiment of the invention.

FIG. 13 illustrates a schematic cross sectional view of a pixel structure of a display device according to a specific embodiment of the invention.

FIG. 14 shows a simplified flowchart illustrating a method of operating a pixel of a display device according to an embodiment of the invention.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Many display technologies waste large amounts of energy by providing substantially more light than necessary to illuminate display areas of the display devices. This inefficiency is particularly problematic in the field of displays that involve the uniform illumination of a rear-facing display surface of the display. This problem can be somewhat ameliorated by the use of pixels that can be discretely illuminated using, e.g., OLED and Plasma display technologies. Unfortunately, an amount of light deliverable to any single pixel is still limited by the output achievable by that particular pixel. For these reasons a display capable of efficiently producing substantial amounts of light in localized portions of the display area is desired.

Light distribution systems for display assemblies often suffer from substantial amounts of light waste. In particular, backlit displays that don't have discrete light sources for each pixel often waste the most energy as the amount of light delivered to each pixel generally stays constant preventing the savings of energy during dark scenes requiring less light. In some cases, this waste light can leak around the edges of the display, thereby degrading performance of the display. Even displays including waveguides that distribute light along the back of a panel are often inefficient as the waveguides are generally configured to spread light evenly over a predefined area.

One solution to this problem is to include valves in the waveguide structure that allow light entering the waveguide structure to be asymmetrically distributed along a display assembly in accordance with an input signal being received by the display assembly. The valves can be distributed throughout the waveguide structure in many ways including but not limited to a junction between a portion of the waveguide structure receiving light and multiple waveguide branches configured to deliver light to numerous pixels of the display assembly. In this way, available light can be distributed for its most efficient use to those portions of the display needing the most light. In embodiments where pixels of the display assembly are arranged sequentially along the waveguide branches, each pixel can include its own valve or subpixel location for drawing an appropriate amount of light for each pixel location. Ideally by the time light provided to the waveguide branch reaches the last pixel associated with the waveguide branch substantially all of the light has been emitted through one of the pixels. In this way, light waste can be essentially eliminated. One way to further idealize the display assembly to meet this goal of eliminating or minimizing light loss is to vary the amount of light being introduced into the waveguide structure to an amount appropriate for the current content being displayed by the display assembly.

In some embodiments, each pixel can have its own valve or subpixel associated with a particular color of light. In this way, each subpixel can draw a desired amount of light of a particular wavelength to achieve a desired color and intensity of light at a pixel location associated with the subpixel. For example, in a display assembly configure to provide red, green and blue light to various waveguides of the display assembly each pixel can have red, blue and green subpixels configured to draw light in from associated red, green and blue waveguides associated with that pixel. It should also be noted that the aforementioned valves and subpixels can be configured to draw light in from the waveguides in many ways. In one particular embodiment, the valves and waveguide structures can be formed from variable refractive index materials whose refractive index can be adjusted to modulate the amount of light being drawn through a particular subpixel or valve.

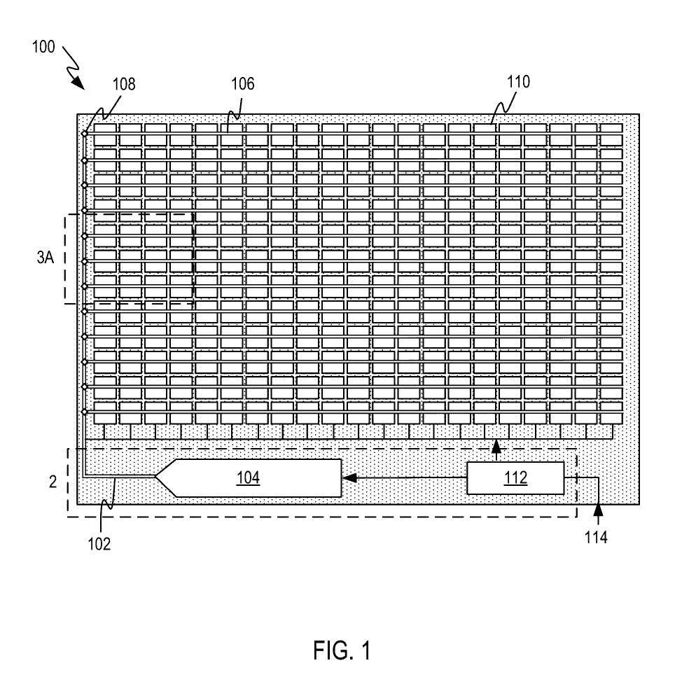

These and other embodiments are discussed below with reference to FIGS. 1-14; however, those skilled in the art will readily appreciate that the detailed description given herein with respect to these figures is for explanatory purposes only and should not be construed as limiting.

Waveguide Structure and Layout

FIG. 1 shows a rear view of a display assembly 100 including an integrated waveguide structure. The waveguide structure includes a waveguide bus 102 that carries light emitted by variable intensity light source 104 to a number of waveguide branches 106. Waveguide bus 102 is configured to propagate light beams through display assembly 100 by restricting the expansion of the light waves as they travel through the waveguide structure. Variable intensity light source 104 can take many forms including, e.g., light emitting diodes, lasers, and the like.

Variable intensity light source 104 can be configured to emit a number of different wavelengths of light. In some embodiments, variable intensity light source 104 can represent multiple light emitting devices such as, e.g., red, green and blue lasers. Valves 108 are utilized to distribute light from waveguide bus 102 into waveguide branches 106. Valves 108 can allow varying amounts of light to enter waveguides associated with each waveguide branch 106. One or more waveguides making up each waveguide branch 106 then deliver light to each pixel 110 of display assembly 100. In this way, the array of pixels 110 can cooperate to form an image, series of images or video that is displayed to a user. While display assembly 100 is shown displaying a relatively limited number of pixels 110 it should be appreciated that this configuration can be scaled to meet high definition, ultra-high definition, or other suitable video standards. For example, a high definition signal or 1080p resolution has a pixel resolution of 1920 (vertical columns) by 1080 (horizontal rows) for a total of 2,073,600 pixels.

Controller 112 of display assembly 100 is illustrated as being communicatively coupled to variable intensity light source 104 and to an array of pixels 110 to allow controller 112 to send command signals to variable intensity light source 104, valves 108 and/or pixels 110. Command signals sent to variable intensity light source 104 by controller 112 can change the overall light output of variable intensity light source 104 in accordance with input signal 114. The overall light output is changed when controller 112 determines the overall amount of light needed for a current video frame is different than the amount of light needed for a previous video frame. In this way, variable intensity light source 104 can be prevented from wasting energy by generating too much light. An amount of light emitted by variable intensity light source 104 can be varied in many ways. When variable intensity light source 104 takes the form of multiple lasers, the amount of light emitted by each laser can be adjusted by applying pulse width modulation to adjust the laser output. In other embodiments, the drive current applied to a solid state light source can be varied to decrease the optical output and reduce wasted energy. One of ordinary skill in the art would recognize many variations, modifications, and alternatives.

Because no extra light or very little extra light is being emitted by variable intensity light source 104, the emitted light is efficiently distributed to each pixel 110 to maintain a low level of light loss/waste. In situations where light loss can be anticipated, controller 112 can be configured to account for the light loss when making light allocation calculations. To accomplish this, valves 108 are utilized that are capable of diverting just enough light to each of waveguide branches 106 sufficient to illuminate pixels 110 associated with corresponding waveguide branches 106. As light is transmitted across display assembly 100 by waveguides of each waveguide branch 106 a portion of the light is conveyed through each pixel 110 as the light travels through the waveguides in accordance with the command signals received at each pixel 110. The arrows extending from controller 112 shows pathways by which command signals are sent from controller 112 to variable intensity light source 104, valves 108 and pixels 110.

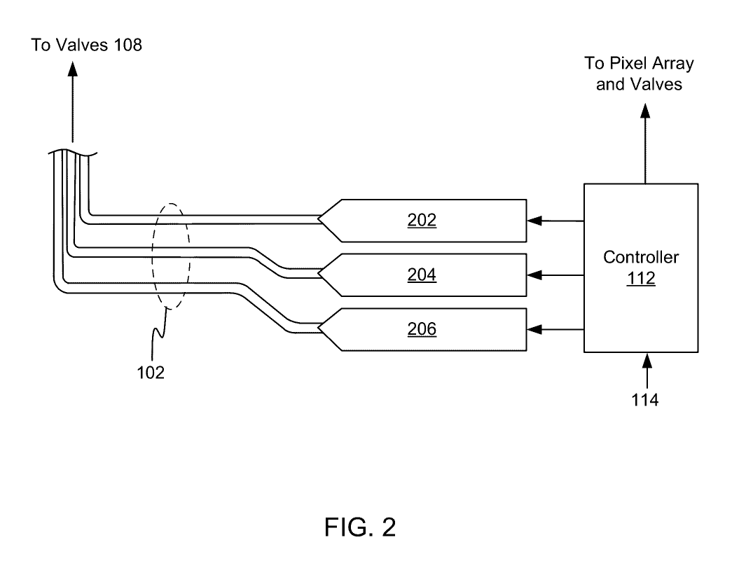

FIG. 2 shows an exemplary embodiment of variable intensity light source 104 and controller 112. FIG. 2 shows how variable intensity light source 104 can include three light sources: first emitter 202, second emitter 204 and third emitter 206. The emitters can take many forms including, for example, lasers, light emitting diodes, and the like. In embodiments using lasers, infrared lasers can be employed with frequency doublers to produce red, green and blue wavelengths of visible light. In such an embodiment, first emitter 202 can emit red light, second emitter 204 can emit green light and third emitter 206 can emit blue light. It should also be noted that other colors can be produced as well, e.g., a yellow laser could be added to the red, green and blue lasers, or alternatively another mix of different color light emitters could be employed. Each of the emitters can be optically coupled to its own discrete waveguide. The waveguides cooperate to form waveguide bus 102, which delivers the emitted light to valves 108 (not depicted).

FIG. 2 also shows how controller 112 communicates with emitters 202-206. Input signal 114 received by controller 112 can be analyzed by controller 112, which determines how much light is required of each color to generate a particular image or frame of a video. Light intensity signals can be generated from this analysis, which are then transmitted to light emitters 202-206. It should be understood that in some embodiments, substantially more light is emitted from light emitter 202 than from light emitter 206 or vice versa. Controller 112 is also in communication with the array of pixels 110 and valves 108. Signals sent from controller 112 to the pixels 110 and valves 108 instruct each pixel 110 making up the pixel array and valve 108 how much light to divert to each pixel 108 and waveguide branch 106.

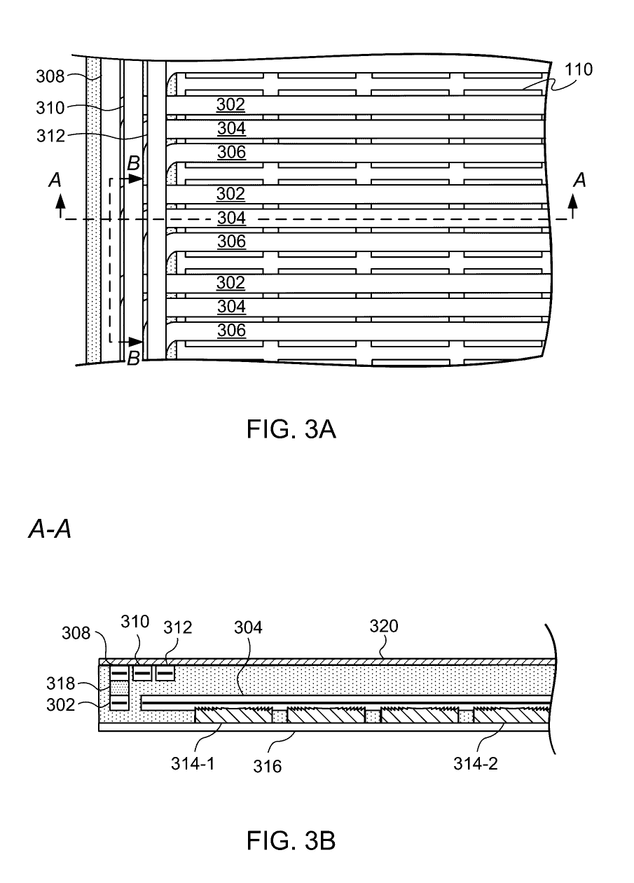

FIG. 3A shows a close up view of a portion of display assembly 100. In particular, each of waveguide branches 106 can be made up of three discrete waveguides 302, 304 and 306. Each waveguide receives light from waveguide bus 102, which is correspondingly made up of three waveguides 308, 310 and 312. As depicted, waveguide 308 of waveguide bus 102 provides light to each of waveguides 302. In some embodiments, waveguide 308 can be responsible for providing blue light to each of waveguides 302, while waveguides 310 and 312 can carry red and green light respectively. While it can be seen that waveguides 302, 304 and 306 do not cover all of the area of each pixel 110, the waveguides making up waveguide branches 106 cover a majority of each pixel 110 to maximize an amount of light that can be delivered through each pixel 110.

FIG. 3B shows a cross-sectional view of display assembly 100 in accordance with section line A-A depicted in FIG. 3A. FIG. 3B shows how each of waveguides 302, 304, 308, 310 and 312 have a laminated structure that includes a core layer surrounded by two cladding layers. In some embodiments, the core layer can take the form of Si₃N₄ and the cladding layers can take the form of SiO₂. The core layer is designed to act as the conduit for transmitting light through each of the waveguides and the thickness of the cladding layers can help to prevent light from escaping the waveguides. FIG. 3B also illustrates subpixels 314. Subpixels 314 can be formed from variable refractive index material whose refractive index can be changed by applying electricity to the variable refractive index material. By varying the amount of electricity delivered to each of subpixels 314 an amount of light escaping from waveguide 304 at each pixel can be changed. In this way, subpixel 304-1 can be configured to redirect a larger amount of the wavelength of light carried by waveguide 304 through its associated pixel than subpixel 314-2 by providing a different amount of electricity to subpixel 314-1 than to subpixel 314-2. Each pixel 110 can be formed from three distinct subpixels 314 that are electrically isolated from each other and optically coupled to different waveguides. In some embodiments, an interface associated with subpixel 314 can be roughened to increase an amount of light transmission between waveguide 304 and subpixels 314. In some embodiments the roughening can take the form of a diffraction grating in the shape of a Fresnel lens. By controlling the geometry of the Fresnel lens, a refractive index of the material making up each subpixel 314 can be tuned so that at certain refractive indexes all light can be prevented from passing through subpixel 314 and at other refractive indexes substantial amounts of light can pass through subpixel 314. It should be noted that a refractive index needed to emit a particular amount of light through subpixel 314 may vary as a function of the amount light passing through that portion of the waveguide to which subpixel 314 is optically coupled. These variables can be handled by and accounted for by controller 112.

FIG. 3B also depicts protective cover 316 which acts as a protector for subpixels 314-1. In some embodiments protective cover can be formed from polymeric material while in other embodiments it can be formed from a layer of glass. In yet another embodiment, protective cover 316 can be formed of any robust optically transparent material. FIG. 3B also depicts valve 318, which functions to control an amount of light transmitted from the waveguide bus to the waveguide branches. Valve 318 can also be formed of variable refractive index material that is the same as or different than the material used to form subpixels 314. In a similar manner as with subpixels 314, valves 318 can vary the amount of light leaving waveguide 308 and entering waveguides 302. Display assembly 100 can include heat conduction layer 320. Heat conduction layer 320 can be formed of a material having high thermal conductivity that covers all of or only particular portions of a rear surface of display assembly 100. In some embodiments, heat conduction layer 320 can be formed from graphene material, which has a particularly high thermal conductivity. Heat conduction layer 320 can be configured to dissipate and spread heat generated by display assembly 100. In particular, heat from light emitters 202-206 can be distributed and dissipated by heat conduction layer 320. In embodiments where heat conduction layer 320 is selectively arranged along a rear surface of display assembly 100, heat conduction layer 320 can be arranged to distribute heat to particular locations well suited for heat dissipation. For example, heat conduction layer 320 can be configured to transfer a substantial portion of the heat to a fin stack in thermal contact with heat conduction layer 320. In some embodiments, a cooling fan can be utilized in conjunction with the fin stack to further improve heat dissipation.

FIG. 3C shows a cross-sectional view of display assembly 100 in accordance with section line B-B as depicted in FIG. 3A. In particular, FIG. 3C shows how waveguide 308 of waveguide bus 102 carries light to multiple waveguides 302. As depicted, substantially more light is transferred from waveguide 308 to waveguide 302-1 than to 302-2. This can be accomplished by applying a different amount of electricity to valve 318 associated with waveguide 302-1 than to valve 318 associated with waveguide 302-2.

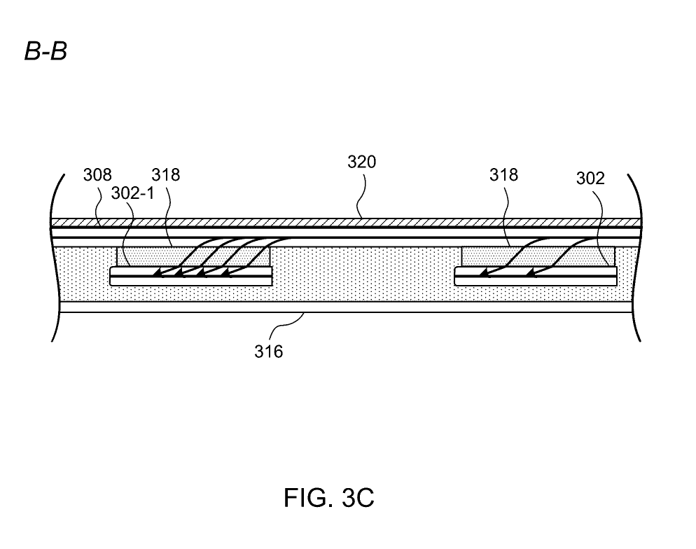

FIGS. 4A-4B show alternative waveguide structures suitable for use with a display assembly. FIG. 4A shows a waveguide structure configured to deliver light to multiple pixels 402. Each pixel 402 can include two subpixels for each color and each of pixels 402 can receive light from six different waveguides, two waveguides for each color. In this way, each pixel can have two different light outputs that can be used to accomplish a variety of visual effects such as for example a three dimensional or in some cases holographic output. FIG. 4B shows a unitary waveguide structure configuration that includes an optical combiner device 452 configured to combine the output from light emitters 202, 204 and 206 into multi-wavelength waveguide 454. Multi-wavelength waveguide 454 carries the different wavelengths of light to valves 456, which control an amount of the light transferred from multi-wavelength waveguide 454 into each waveguide branch 458. Valves 456 can be configured to convey multiple wavelengths of light between multi-wavelength waveguide and waveguide branches 458. Waveguide branch 458 carries the light to individual pixels associated with each waveguide branch 458. Each pixel includes an optical coupling layer 460 formed from variable refractive index material such as crystal polymers. Optical coupling layers 460 can be configured with a thickness and/or refractive index optimized for pulling out only a single desired wavelength or narrow band of wavelengths associated with a particular optical coupling layer/subpixel 460. In this way a single waveguide can carry all the light for each waveguide branch 458.

Although six waveguides providing six different outputs are illustrated in FIG. 4A, embodiments of the present invention are not limited to this particular implementation. As an example, in an embodiment in which eight different outputs are utilized, for example, two polarizations for four colors, eight waveguides could be utilized. One of ordinary skill in the art would recognize many variations, modifications, and alternatives.

FIGS. 4C-4D show an additional alternative waveguide structure embodiment. FIG. 4C shows how display assembly 480 includes variable intensity light source 104 configured to supply light to multiple waveguides 482 and 484. Display assembly 480 includes curved and overlapping waveguides 482 and 484. Because waveguides 482 and 484 can have quite small form factors of less than 100 microns in total height, waveguide overlap can be accounted for by varying the thickness of a layer of variable refractive index material disposed between the waveguides and a front surface of display assembly 480. Furthermore, display assembly 480 can include waveguides 482 with variable widths. As depicted, waveguides 482 get substantially wider towards the right side of display assembly 408, so that they can cover a larger portion of pixel 486. Display assembly 480 can also have variable length waveguides 480. This variable length waveguide configuration can be beneficial when less light is required to be routed to a particular portion of display assembly 480. It should be noted that display assembly 480 is depicted as having a wavy shape but that any shape is possible and can be sized in any number of ways to match a display area of a display to which it is designed to be associated with. For example, display assembly 480 can be part of a multi-layer, flexible polymeric substrate that bends and flexes to fit within a device. Display assembly 480 could take the form of a ring or polygon to fit a particular device shape of size. The flexible and shape agnostic qualities of the display make this type of display assembly particularly well suited for use with a wearable device.

FIG. 4D shows a cross-sectional view of pixel 488 and depicts how waveguide 452 can be overlapped by waveguide 454 by sizing subpixels 314-1 substantially thicker than subpixel 314-2. In this way, pixel 488 can be driven by three different subpixels, subpixel 314-1, 314-2 and 314-3. While FIGS. 4C-4D show a fairly different embodiment than those previously depicted it should be understood that any one of the features depicted in FIGS. 4C-4D can be combined with any one of the previously discussed embodiments. For example, display assembly 100 could include overlapping and crisscrossing waveguides.

Electrical Configuration

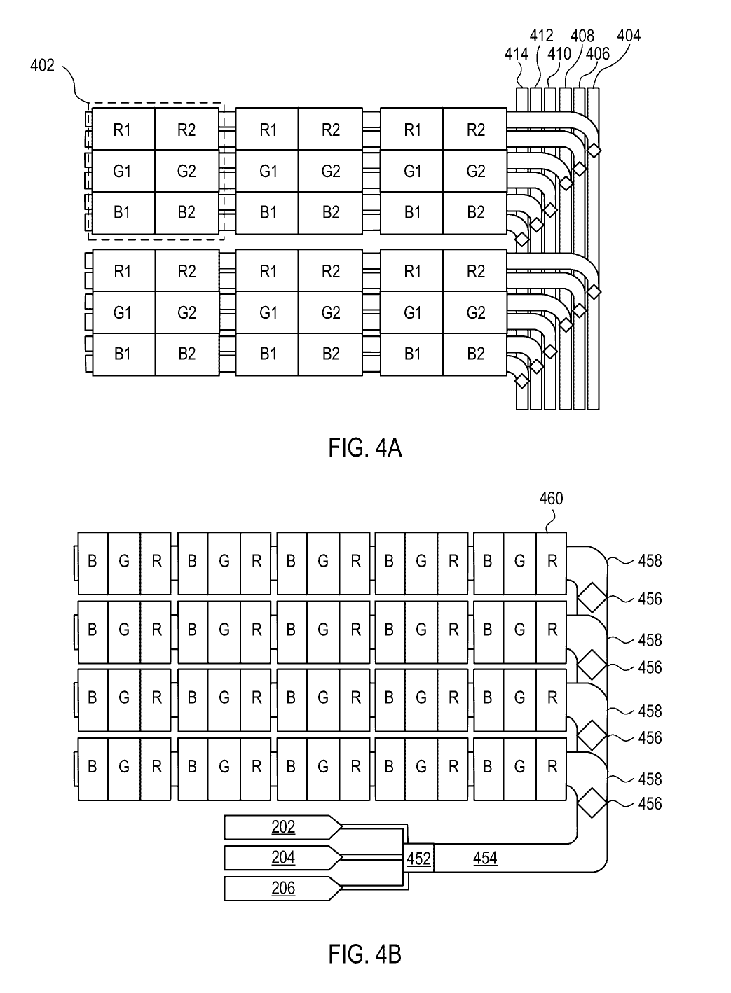

FIG. 5A illustrates a system 500 that can be a portion of the display assembly 100 of FIG. 1. The system 500 is illustrated as including subpixels 314a-s. Subpixels 314d-f are illustrated as being part of a pixel 110. Also illustrated are valves 318a-f and corresponding waveguides 308-312 and branches 302a, 302b, 304a, 304b, 306a, and 306b. As illustrated, waveguides 302a and 302b can be associated with a particular color or wavelength of light emitted by a variable intensity light source. As illustrated, waveguide branches 302a and 302b are associated with waveguide 312 that is associated with the color red. By adjusting the amount of light transferred between waveguide 312 and waveguide 302a, the amount of red light propagated to subpixels 314a, 314d, and 314g can be altered. Similarly, waveguide 310 is illustrated as propagating green light and waveguide 308 is illustrated as propagating blue light. By increasing the amount of light propagated through the valves 318a-c, the amount of red light propagated to subpixels 314a-314i can be adjusted. By adjusting, in equal proportions, the amount of each color of light transported to the subpixels 314a-314i, the brightness/intensity of the pixels that are comprised of subpixels 314a-314i can be adjusted.

The valves 318a-f, as illustrated, can each propagate light to a plurality of pixels. An additional mechanism is illustrated that can control the amount of light and the color of light emitted by each unique pixel of the plurality of pixels. Each of subpixels 314a-s of a pixel 110 can comprise an electro-optic polymer whose refractive index can be adjusted, such as by the application of an electric voltage. By individually altering the refractive index of each subpixel, the difference in refractive index between a subpixel and a corresponding waveguide structure branch that the subpixel is thereto coupled can be adjusted. In this manner, light traveling through waveguide branches 302-306 can be propagated out through a subpixel or not propagated out of the display and instead allowed to propagate along waveguides 302-306 and be available to other subpixels optically coupled to the waveguides 302-306.

FIG. 5A also illustrates several column drivers 506a-c and several row drivers 504a-f to better illustrate an example subpixel addressing mechanism. A voltage source 508 is illustrated comprising a negative polarity and a positive polarity. It should be understood that the negative and positive polarity only illustrate a voltage difference that is output by the voltage source 508. The voltage difference can be propagated to a subpixel 314 of the display to alter the refractive index of the subpixel. As described herein, a subpixel 314 can comprise an electro-optic polymer that can be optically coupled to a waveguide. By applying a voltage difference across a subpixel 314, the light propagated from a waveguide to the subpixel can be adjusted.

For example, by closing row driver 504a and column driver 506a with simultaneously opening row drivers 504b-504f and column drivers 506b-c, a voltage difference can be applied to subpixel 314a. Although the drivers are illustrated as being open and closed switches, it should be understood that various mechanism and configurations can be used to apply varying voltages and/or currents to an electro-optic polymer of a subpixel 314 (or a valve 318). A constant voltage source can be Pulse-Width Modulated (PWM) in order to adjust an average voltage applied to a subpixel that can be less than the voltage output by the constant voltage source. Alternatively, the voltage source 508 can be linearly adjustable. Although a linear voltage source can be less efficient than a switching (i.e., PWM) voltage source, a linear voltage source can create relatively less electromagnetic emissions as compared to a switching source. Electro-optic polymer cells can be manufactured requiring relatively little power to alter the refractive index of the cell and therefore may require minimal power to alter the refractive index. Therefore, a linear voltage regulator may be advantageous for altering the refractive indexes of subpixels 314 of the display assembly 100.

By using the row 504a-f and column driver 506a-c, individual subpixels 314 of a subpixel array can individually be addressed in a time varying manner. For example, the previous example included enabling row driver 504a and column driver 506a. At another time period, row driver 504a and column driver 506b can be enabled to address subpixel 314d and adjust its refractive index accordingly. By quickly switching between subpixels, the array of subpixels comprising a displayed image can be altered. An array can be subdivided into several such addressable arrays to decrease the time necessary to display an image.

To further explain the functionality of a pixel, reference will now be made to pixel 110. For this example, subpixel 314d will be referenced as a red subpixel, subpixel 314e will be referenced as a green subpixel, and subpixel 314f will be referenced as a blue subpixel. For pixel 110 to appear as a white pixel to a user, each of subpixels 314d-f can be configured to emit relatively equal amount of red, green, and blue light. The summation of the red, green, and blue light can appear as white light to a user. Furthermore, the intensity of white light emitted by the white light emitting pixel (i.e., the brightness of the pixel) can be controlled by varying the amount of light emitted by each subpixel 314d-f while maintaining equal amounts of each of red, green, and blue light components. Alternatively, different colors of light emitted by the pixel 110 can be adjusted by altering the proportions of light emitted by each subpixel 314d-f. For example, a blue-green teal color can be emitted by a pixel 110 by emitting relatively more light from the green subpixel 314e and blue subpixel 314f than from the red subpixel 314d. If a pixel is desired to appear black, all of the subpixels of the pixel can be configured to prevent emittance of light. In this manner, the color and brightness of each pixel can be adjusted by addressing each subpixel of the pixel.

As explained herein, the pixel 110 can also be configured as a black pixel by adjusting the amount of light transmitted through the valves 318a-c. By preventing light from being propagated into the waveguide branch associated with waveguides 302a, 304a, and 306a, pixel 110 (and all pixels coupled to the waveguide branch) can appear as black pixels. Additionally, the valves 318 or subpixels 314 may not be able to prevent all light from being propagated to a user. Valves 318 can be used in conjunction with corresponding subpixels 314 to prevent light from propagating using two separate mechanisms and providing a “deeper” black color to a pixel.

FIG. 5B illustrates an exemplary display system 502 embodying features of the disclosure in another example configuration. In the system 502, each pixel 110 comprises six subpixels (labeled “R1”, “R2”, “G1”, “G2”, “B1”, and “B2”). In system 502, each pixel 110 comprises two sets of primary color subpixels, each set being capable of producing substantially all colors of the visible light spectrum. Using two sets of these pixels can have several advantages. For example, each set of primary colors can be displayed, using various technologies, to a different eye of a user. In this manner, three dimensional images can be displayed. For example, each set of primary color subpixels can be polarized in different directions. A user can wear glasses with polarization filters for both eyes, each aligned to allowed light from one set of primary color subpixels. A pixel 110 can comprise many different combinations and numbers of differently color subpixels. For example, a pixel can comprise two green subpixels, one red subpixel, and on blue subpixel. A pixel can comprise one green, one yellow, one blue, and one red subpixel. Additionally, the geometry of each pixel and subpixel can take many different shapes. Although the pixels and subpixels are illustrated as being rectangles, each can be take a polygonal, circular, or organic shape. A pixel 110 could, for example, comprise two red subpixels that are each physically smaller in size than either a blue or green subpixel of the pixel.

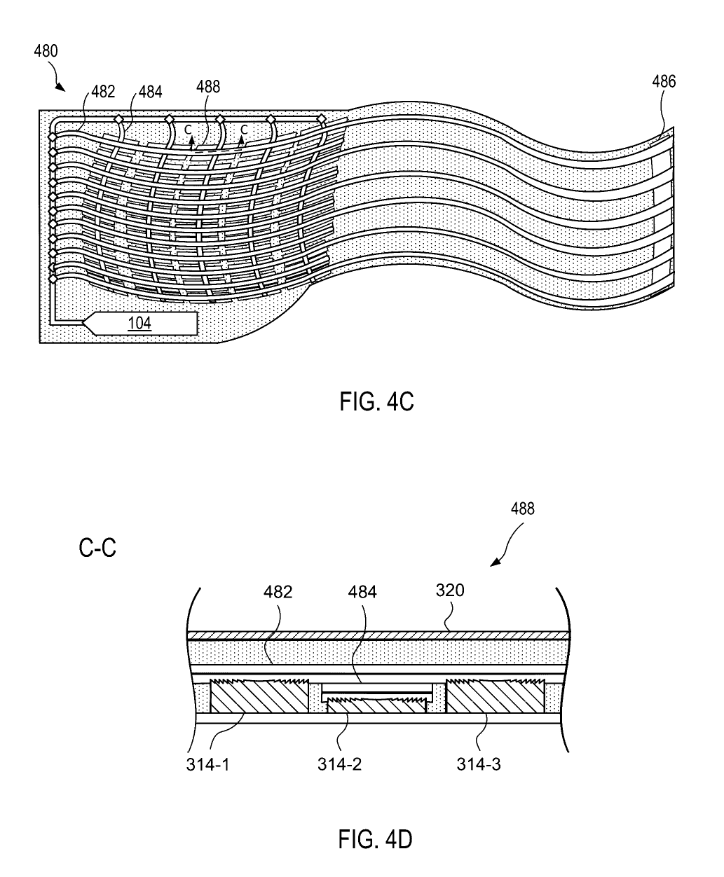

FIG. 6 illustrates a system in which a controller 112 is coupled to an array 602 of pixels 110 (each pixel 110 being addressable by controller 112), multiple light emitters associated with a variable intensity light source 104, and multiple valves 108. Note that the pixel array 602, variable light sources 104, and the valves 108 are not coupled in a particular pattern to emphasize that the controller 112 can be configured to control these elements in any particular combination or configuration. For example, the system 600 illustrated by FIG. 6 can include multiple light emitters associated with variable intensity light sources 104, each coupled to one or more respective portions of the pixel array 602 using, for example, waveguides (not shown). The valves 108 can be coupled between the light emitters of variable intensity light source 104 and pixel array 602 in a variety of configurations. The valves 108 can also be coupled between two light emitters and a common waveguide, between pixels 110 of the pixel array 602, or in series along a singular waveguide structure (not shown) in various configurations, for example. The variable light source(s) 104 can be arranged to edge light the display.

The controller 112 can be or include a processor, Field Programmable Gate Array (FPGA), Application-Specific Integrated Circuit (ASIC), or other logic and/or electronic components. The controller 112 can include several integrated chips on a singular or multiple substrates. The controller 112 can comprise several circuit cards each with various interconnects, integrated circuits, and/or functions. The controller 112 can include a tuner or other such input device for receiving video information transferred wirelessly or through a cable (such as via a coaxial cable or via Ethernet). The video information can be encoded in a variety of manners including Moving Picture Experts Group (MPEG), Audio Video Interleave (AVI), QuickTime, or other formats. The controller 112 can be configured to derive image characteristics from the received video information including brightness, gamma, contrast, gamma, or other characteristics. Using this information, the controller 112 can optimize images displayed by the display system 600 or 100 as will be described herein.

The previously recited MPEG compression technique can generally consist of transferring a plurality of frames. Frames can be classified into different types. Some frames can include all of the information necessary to produce an image at a certain time (i.e., an intra coded frame, I-frame, or key frame). Subsequent frames may contain information pertaining to altering only a portion of the frame (i.e., a predicted frame). In this manner, certain portions of the image can remain static and no information need be transferred/stored to change these static portions. Therefore, this technique can be used to compress video data. However, some of the techniques described herein for predicting the luminance of a enhancing the contrast of a display can benefit from obtaining an overall evaluation of an image at a given time. Although MPEG is used here as an example, it should be understood that various other compression and/or encryption techniques can be used with a display system. Encryption schemas are becoming increasing popular to protect copyrighted works from unauthorized reproduction (such as high-bandwidth digital content protection). Other compression or encryption techniques can use wave, wavelet, particle, or combinations of various techniques.

### Display Driving Processes

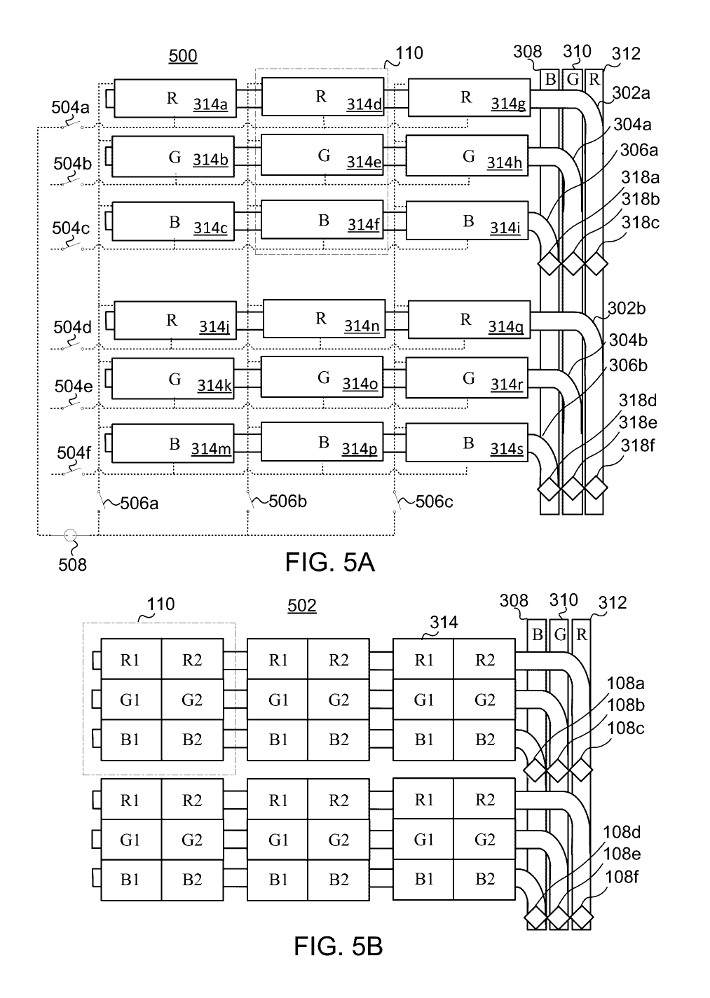

FIG. 7 illustrates a high contrast image 700 to illustrate features of the disclosure. For example, region 706 of the image 700 indicates a relatively bright area of the display. Region 708, in contrast, indicates a relatively dark area of the display. Using the display technologies disclosed herein, light can be routed to pixels in the region 706 and away from region 708 to enhance the contrast of the image 700 when displayed via the display assembly 100. If the valves 318 are arranged to isolated rows of pixels, for example, then valves corresponding to the rows of pixels 702 can be closed to prevent or minimize light propagated through waveguide branches coupled to pixels in region 708. By minimizing the light available to these pixels, light emitted by a variable intensity light source 104, for example, can be routed through valves corresponding to rows of pixels 704 and into area 710. Additionally, electro-optic polymers in region 706 can be configured to propagate light out of the display. By propagating light to pixels of area 706, the light emitted by a light source can be concentrated to these few pixels. By concentrated the light, the contrast of the display can be enhanced. In a typical LCD display, for example, each pixel of the display is typically able to output a minimum and maximum intensity of light regardless of the configuration of other pixels of the display. In contrast, the display assembly 100 can route a light budget output by a light source to any number of pixels. If the pixels are greater in number, each will be relatively dimmer. If the pixels are fewer in number, each pixel will be relatively brighter.

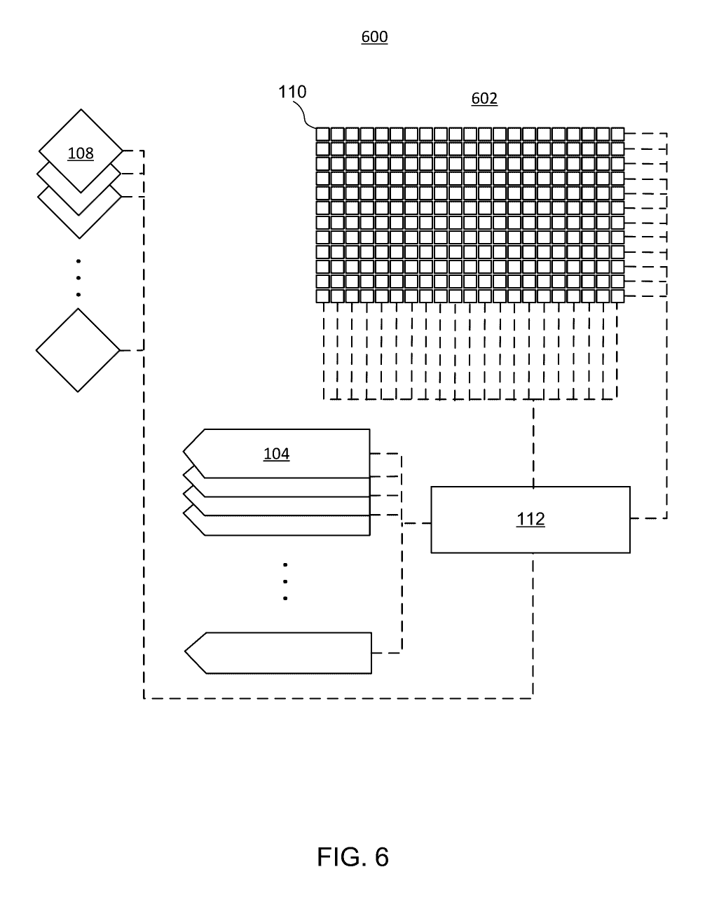

FIG. 8 illustrates a flowchart 800 of a method of operating a display (such as the display assembly 100). In step 802, image information can be received by the display. For example, the controller 112 can receive information such as a digital representation of an image. Digital information can be encoded to represent the information in various manners. For example, a compression algorithm can be used to minimize the amount of data transferred for an image, or a group of images. MPEG formats are widely used to transmit videos to digital displays. MPEG formats can transmit video information using different types of frames. For example, a base frame can be transmitted containing data necessary to represent an entire image. Follow on transmitted frames can contain only predicated frames in which only portions of the image that have changed from the base frame are transmitted and therefore updated by the display. Several other techniques can also be used such as droplet, wave, or other types of compression.

Using the information, the controller 112, in step 804, can then derive image characteristics from the image, using the information from step 802. Characteristics can include a total amount of light for an image to be displayed, a subset pixel intensity of an amount of light to be displayed by a subset of the pixels of the display, the white balance of the image, the contrast ratio of the image, gamma correction information, the hue or saturation of the image, or other information. As an example, the total amount of light needed to display the image can be analyzed by summing the luminosity encoded in each pixel of the image. As described earlier, the information can include only a subset of the image to be displayed as is commonly the case for digitally encoded video streams. For example, predicated frames of MPEG can be transmitted that only contain a portion of the image to be displayed. Therefore, the controller 112 can contain a frame buffer and the total amount of light can be derived from the image data of the frame buffer. In this manner, the frame buffer can contain information associated with a current image to be displayed that is updated by the information.

In a similar manner, the subset pixel intensity can be derived using the information. A subset pixel intensity can be associated with pixels (or subpixels) coupled to a common waveguide. The amount of light propagated into the common waveguide can be controlled with a valve. Therefore, a subset pixel intensity can indicate the total amount of light to be propagated into a waveguide branch by a valve to be available to pixels (or subpixels) of the waveguide branch. A frame buffer can also be used for this information. As explained herein, a valve can be associated with a row of a display. MPEG predicated frames are usually encoded in blocks of an image. Therefore, a frame stored in a frame buffer may be necessary to obtain the total amount of light to be allocated to a row of the image. However, it should be understood that this is just one example. The image information can be encoded in a manner that matches the configuration of the display. For example, the predicated frames of MPEG can be altered to be rows instead of blocks. Alternatively, the valves can be configured to align with common encoding schemes. For example, the valves can be arranged to form blocks of pixels to align with predicated frames of existing MPEG encoding schemas. The valves can be arranges in a variety of configurations including rows, columns, blocks, circles, waves, or other shapes.

In step 806, a calibration profile can be applied using the information. The calibration information can be arranged and applied to a variety of the steps of the method. For example, the calibration profile can contain calibration information associated with a variable light source of the display. For example, the amount of light emitted by the variable light source may be adjusted, for example, by applying a variable voltage to the variable light source. The light emitted by the light emitter may not be linear in response to the applied voltage. Therefore, a calibration profile may be used as a lookup table to help linearize the output. Alternatively or additionally, each variable light source of a display can individually be calibrated in the same manner to account for manufacturing differences. Certain vendors of light emitters may be associated with a calibration profile. Individual colors emitted by light emitters of a light source can also be individually calibrated.

A calibration profile can also be applied to electro-optic polymers used in pixels or valves of a display. As described herein electro-optic polymers can be used that have varying refractive indexes in response to an applied voltage or other electrical signal. However, the change in the refractive index may not be linear to the change in the electric signal. Therefore, a calibration profile or lookup table can be useful to linearize the response of the electro-optic polymer. Additionally, a calibration profile can include corrections for a physical configuration of a display device. For example, a pixel in the upper right corner of a display may receive more or less light than a pixel in the lower left corner of the display from a common light source depending upon the structure of the device. For example, if the light is propagated to the pixels using a waveguide, the geometry of the waveguide can affect how much light is propagated to each pixel. Due to losses in the brightness of light as it is propagated along a waveguide, pixels located further away from a light source may receive relatively less light than pixels located closer to the light source.

The calibration information may also include a tree of lookup table/variables depending upon various configurations of the display. If, for example, certain valves of the display are configured to propagate ranges of light, the calibration information can include correction factors to other valves and/or pixels of the display. The calibration information can then take the form of a tree and a spanning algorithm can be used to traverse the calibration information depending upon the current or a desired future configuration of the display.

At step 808, a light beam is emitted from a variable light source as a function of the total amount of light determined via step 804. The total amount of light can pertain to an image to be displayed. The total amount of light can be referred to as a light budget, as it can be allocated to the pixels of the display using the display assembly 100, for example. The total amount of light can be calculated by aggregating the brightness of each pixel of an image to be displayed. As one example, each pixel of the image can be represented by digital information. A portion of the digital information can be value corresponding to the brightness of the pixel. By summing these values, the total amount of light of the image can be determined.

However, given that various encoding protocols can be used to minimize the amount of data transmitted to the display, various additional steps may need to be performed. For example, as stated herein, MPEG or other encoding schema can transmit only a portion of the data to be displayed. The portion of information to be displayed can be a specific area of the image (a predicated frame) or techniques wherein multiple pixels are represented by a formula or a shared data value. For example, adjacent pixels can be described as a function that described changes in color and/or brightness between the adjacent pixels to reduce the amount of information needed to pass the information. As such, a controller determining the total amount of light can include a frame buffer. The frame buffer can be used as a storage area of an image to be displayed, i.e. a frame. The frame can include image data pertaining to the whole image to be displayed even if the received information does not contain all necessary information to display the image. For example, the frame can contain image information that is updated by received/encoded image information. By using the frame, the total amount of light pertaining to an image can be determined even if received information is encoded and/or only contains a portion of pertinent information necessary to display an image.

The total amount of light (luminance of the pixels) can therefore be referenced as Lₜₒₜₐₗ and the luminance of each pixel as Lₚᵢₓₑₗ. An equation for the total amount of light can then take the form of Lₜₒₜₐₗ=Σᵢ₌₁ⁿL_{pixel i} where n is the total number of pixels of the display. However, given time necessary to sum all of the brightness of all pixels of the display, it may be advantageous to use a sampling schema wherein only a luminosity of a subset of the total number of pixels is summed and then applied to the whole image. As an example, only every other pixel may be added using the luminosity and then end result multiplied by two to derive the total amount of light of the display. Additionally algorithms can be implemented including adaptive or variable algorithms that emphasize certain areas of an image over others (for example, the center of an image or a detected high brightness area of an image). As an alternative method, if the encoded information only contains a portion of the display, the luminosity of the pixels of the encoded information can be summed and either added or subtracted from a running tally of the total luminance of the display. As yet another alternative, the information can include an offset field wherein the total amount of light of the image is encoded or an offset to a running tally of the screen luminosity. Still in other embodiments, the information may only include luminosity information encoded as being relative to other pixels of the display instead of to an absolute value. In this instance, the total amount of light can be determined by calculating the amount of light necessary to display the relative differences in brightness between the pixels (i.e., the contrast of the image). A total amount of light can then be chosen to enhance or minimize the differences in brightness between pixels of the displayed image to alter the contrast of the displayed image.

A step 810, a valve is directed to propagate light to a subset of pixels. As described herein, valves can be used to optically couple waveguides of the waveguide bus with waveguides of a waveguide branch. A plurality of pixels can be coupled to the waveguide branch. Each valve can be configured to propagate light from a waveguide of the waveguide bus into a waveguide of the waveguide branch to be available to the subset of pixels associated with the associated waveguide of the waveguide branch. The light available to the subset of pixels can be the subset pixel intensity derived at step 804 of the process. Wherein the total amount of light can be calculated as the summation of the total amount of light available to all pixels of the display, the subset pixel intensity can be calculated as the summation of light available to a subset of the pixels. Therefore, the subset pixel intensity can be a subset of the total amount of light. By configuring a variable light source to emit the total amount of light and directing the valve to propagate a portion of the light beam to the subset of pixels, the subset of pixels can receive a portion of the light beam equivalent to the subset light intensity. The subset pixel intensity can therefore be referenced as L_{subset} and the luminance of each pixel of the subset as Lₚₛ. An equation for the total amount of light can then take the form of L_{subset}=Σᵢ₌₁ⁿL_{ps i}, wherein n is the number of pixels in the subset. Additionally, the total amount of light can be expressed as Lₜₒₜₐₗ=Σᵢ₌₁ⁿL_{subset i}, wherein n is the number of subsets in the display.

By using the total amount of light of an image to be displayed and subset pixel intensities, a controller of a display system (such as display assembly 100) can allocate light to various subsets and pixels in an iterative fashion. For example, the controller can calculate the amount of light necessary for each subset in parallel. The controller can then add the subset pixel intensities to obtain the total amount of light of the image. The controller can then command a variable light source the emit the total amount of light (and optionally accounting for calibration parameters). The controller can, in parallel, command valves of the display to propagate a portion of the total amount of light to each subset according to the corresponding subset pixel intensity. Furthermore, the controller can, in parallel, command subpixels of each subset to emit light as will be discussed herein.

Additionally, the contrast ratio of the display can be improved by directing valves of the display. By reconfiguring the valves, light from a light source can be concentrated into specific groups of pixels. Light to other pixel groups can be minimized using the valves to simultaneously reduce leakage emissions from the other pixels. In addition to reconfiguring the valves, the amount of light emitted from light source(s) can be adjusted at step 810. The amount of light output by the light source can be limited to improve the contrast of the displayed image. For example, if many of the valves are closed to concentrate the light emitted from the light source into a relatively small number of pixels, it may be difficult to control the amount of light emitted by the pixels with a high degree of accuracy. As another example, the light emitted by such pixels may be too bright and therefore uncomfortable to a user. In these instances, it may be beneficial to limit the light output by one or more light sources.

At optional step 812, a refractive index of a pixel or subpixel can be adjusted. As stated previously, altering the refractive index of a pixel or subpixel can be used to alter the color and/or brightness of a pixel of a displayed image. Altering the refractive index can be accomplished by applying electrical power to an electro-optic polymer of each subpixel. Each subpixel can include electrodes. The electrodes can be transparent. As one example, the refractive index of an electro-optic polymer can be voltage controlled. In other words, altering the voltage applied to electrodes of an electro-optic polymer can alter the refractive index of the electro-optic polymer. This voltage can be controlled by a linear or switching voltage regulator. Linear voltage regulators advantageously can emit minimal Electromagnetic Environmental Effects (EEE). An advantage of reducing radiating electromagnetic radiation EEE is that minimal additional shielding may be needed to contain the radiation. Minimizing shielding can minimize the cost, weight, and reduce the number of steps required to manufacture such a device.

A previous state of the display can be used to alter the state of pixels to display subsequent images. As discussed herein, several methodologies can be used by the display assembly 100 described herein to enhance the viewing experience of a user. Many of these techniques can be used to enhance, for example, the contrast ratio of a viewed image. However, the techniques can lead to inconsistent viewing experiences when viewing videos, for example. As one particular example, a particular image may consist of a relatively bright image over the entire viewing area. In other words, the total amount of light in the image may be relatively high. In a subsequent image, only a portion of the image may be relatively bright compared to the rest of the image. If the contrast ratios for both images were maximized, the total amount of light of the first image would be concentrated into the bright portion of the second image and the brightness of the area of the second image may substantially exceed a brightness of the first image. This effect may result in an unpleasant and/or disconcerting viewing experience. Therefore, some level of analysis of images over time can help account for such difference and result in a more ideal viewing experience for a user. Alternatively, a relatively small bright area of a first image may be displayed followed by an overall bright second image. In this instance, the absolute brightness of the first image may exceed the absolute brightness of the second image if the contrast ratios were maximized.

Several methodologies can be used to minimize the above mentioned artifacts. For example, a time delayed brightness change can be implemented such that sudden shifts between areas becoming brighter or dimmer can be minimized. Threshold limits on the absolute amount of light transmitted by the display can be implemented to reduce occurrences of these artifacts or to ensure that the display does not exceed comfortable viewing brightness levels.

Several additional features can be accounted for in order to improve the displayed image using the display assembly. As an example, a distance between a pixel and a light source can be accounted for. As the light travels along a waveguide branch situated between the light source and the pixel, the amount of light captured within can slowly dissipate due to leakage between the waveguide branch and surrounding materials or through other phenomena. As light travels along the waveguide branch less light may be available for pixels further away from the light source. The distance need not be a linear distance but can account for the distance that the light travels between the pixel and the light source.

It should be understood that the geometry of the waveguide structure can also effect the amount of light available to each pixel of a waveguide branch. Each waveguide branch can be arranged to be coupled to a linear array of pixels, as illustrated in FIG. 5A. Alternatively, waveguide branches can be arranged to form different patterns of pixels in various fashions. For example, a waveguide can be circular and therefore form a circular array of pixels. Alternatively, a waveguide can follow a serpentine pattern through a display and pixels coupled to the waveguide branch can likewise form a serpentine pattern. Therefore, the calculation of the distance between the light source and a pattern can become relatively complex and, in addition, may require the computation of additional dependent or independent variables.

One such variable can be the state of a pixel between the target pixel and the light source and coupled to the same waveguide branch. For example, referencing now FIG. 5A, light can travel from waveguide 312 into waveguide 302a. The state of subpixel 314g can affect the amount of light available to subpixels 314d and 314a. For example, if subpixel 314g is configured to inhibit the emittance of light from the display, more light may be available to subpixel 314d than if the pixel 314g were configured to emit light from the display. This is because there can be a finite amount of light available from a light source and/or valve 318c. By emitting light from a subpixel of a waveguide 302a, less light may be available to other subpixels optically coupled to waveguide 302a.

Another variable can be the actual geometric shape of the waveguide and/or structure. Each waveguide can individually be designed with varying cross-sectional shapes, from different materials, and/or from different layers of materials. The amount of light that is dissipated as light travels along a waveguide can therefore differ and be accounted for. As one example, an amount of light supplied to a waveguide can be configured to compensate for dissipation of light as it travels along the waveguide branch to subsequent pixels. For example, the calculation described above regarding the distance between a pixel and the light source can be obviated through the use of such techniques. Additionally, the geometry of a waveguide can be configured to provide more light to some pixels and less to others in a non-linear fashion. Such a configuration may be beneficial when it is desired to have a center of a display brighter than the surrounding layers. Alternatively, certain colors of subpixels can be enhanced or alternatively repressed in some portions of a display.

### Pixel Output Coupler Description

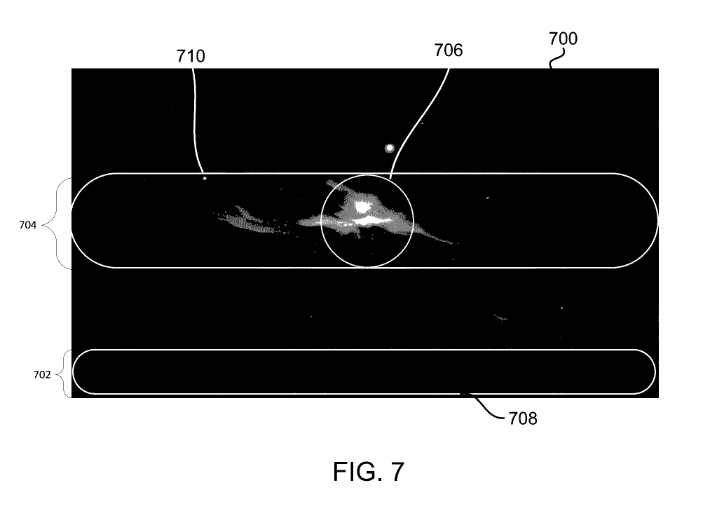

FIG. 9 illustrates a schematic partial top view of a display device 100 according to an embodiment of the invention. The display device 100 includes a plurality of pixels 110. Each pixel 110 may include three sub-pixels 314-1, 314-2, and 314-3, one for each of the primary colors, according to an embodiment of the invention. Each sub-pixel 314-1, 314-2, or 314-3 is coupled to a respective waveguide 302, 304, or 306, and configured to emit an adjustable amount of light from the light wave propagating in the respective waveguide, as discussed in more detail below. Referring to FIG. 9, waveguide 302 is operable to propagate light in the red portion of the visible spectrum. Accordingly, sub-pixel 314-1 is labeled with R to represent the red portion of the visible spectrum. Waveguide 304 is operable to propagate light in the green portion of the visible spectrum. Accordingly, sub-pixel 314-2 is labeled with G to represent the green portion of the visible spectrum. Waveguide 306 is operable to propagate light in the blue portion of the visible spectrum. Accordingly, sub-pixel 314-3 is labeled with B to represent the blue portion of the visible spectrum. As will be evident to one of skill in the art, if more than three primary colors are utilized, additional waveguides and corresponding sub-pixels can be provided in accordance with the number of primary colors utilized in the display. One of ordinary skill in the art would recognize many variations, modifications, and alternatives.

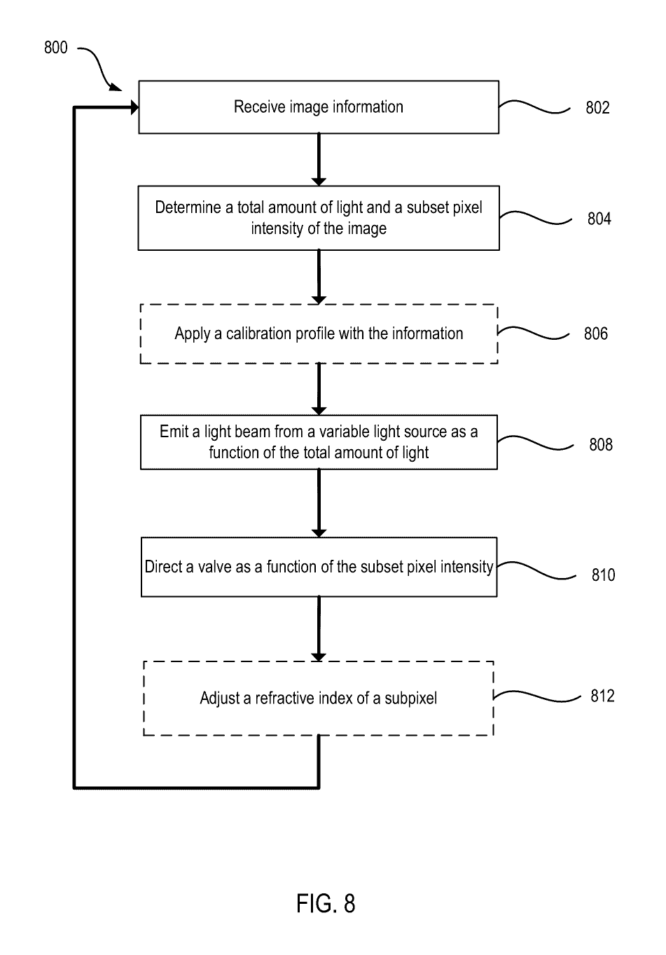

FIG. 10 illustrates a schematic cross sectional view of a pixel structure (i.e., the structure of a sub-pixel) of the display device 100 along the C-C direction as indicated in FIG. 9, according to an embodiment of the invention.

The pixel structure 901 is supported by a substrate 910 and utilizes a waveguide 304 coupled to the substrate 910. The waveguide 304 includes a first cladding layer 922 formed on the substrate 910, a core layer 924 formed on the first cladding layer 922, and a second cladding layer 926 formed on the core layer 924. According to embodiments of the invention, the substrate 910 may comprise a plastic polymer material, a semiconductor material, a ceramic material, or the like. In some embodiments, adhesion layers, buffer layers, and the like are utilized between the various layers of the structure. Accordingly, the layers illustrated in FIG. 10 do not have to be in physical contact with each other, but may have intervening layers as appropriate for the particular application. Thus, in the description above, the statement that the first cladding layer 922 is formed on the substrate 910 does not imply that there are no intervening layers since adhesion, buffer, and other suitable layers can be utilized to facilitate fabrication of the device. One of ordinary skill in the art would recognize many variations, modifications, and alternatives.

A light wave may be confined in the core layer 924 by total internal reflection, which may occur if the refractive index of the core layer 924 is greater than that of the surrounding layers, namely the first cladding layer 922 and the second cladding layer 926. According to embodiments of the present invention, the first cladding layer 922 has a first refractive index, the second cladding layer 926 has a second refractive index, and the core layer 924 has a third refractive index. The third refractive index of the core layer 924 is greater than the first refractive index of the first cladding layer 922 and the second refractive index of the second cladding layer 926 at a visible wavelength, so that a light wave of a visible wavelength may be confined in the core layer 924, and propagate along a longitudinal length of the waveguide 304 (in the direction of the thick arrow shown in FIG. 10).

Evanescent light waves are formed in the first cladding layer 922 and the second cladding layer 926 with an intensity that exhibits exponential decay as a function of the distance from the boundary between the core layer 924 and the first cladding layer 922, and from the boundary between the core layer 924 and the second cladding layer 926, respectively.

In an embodiment, the first cladding layer 922 and the second cladding layer 926 comprise silicon dioxide (SiO₂), which has a refractive index of about 1.45 in the visible wavelength region. The core layer 924 comprises silicon nitride (Si₃N₄) in an embodiment, which has a refractive index of about 2.22 in the visible wavelength region.

Although FIG. 10 illustrates a waveguide 304 utilizing SiO₂ and Si₃N₄, other dielectric materials of the proper refractive indices may be used for the first cladding layer 922, the second cladding layer 926, and the core layer 924. In addition, the first cladding layer 922 and the second cladding layer 926 may comprise different materials. Other examples of core layer materials include SiₓN_{y}, non-stoichiometric silicon nitride, silicon oxynitride, InGaAsP, Si, SiON, benzocyclobutene (BCB), and the like. Other examples of cladding layer materials include SiₓO_{y}, SiON, alumina (Al₂O₃), magnesium oxide, titanium oxide (TiO₂), and the like. According to some embodiments, the first cladding layer 922 and the second cladding layer 926 may comprise a plastic material, such as poly(methyl methacrylate) (PMMA).

In an embodiment, the waveguide 304 is a single-mode waveguide. Because there is very little light scattering from a single-mode waveguide, a screen contrast ratio of more than a million to one may be achieved according to some embodiments. The core layer 924 has a thickness of about 0.5 μm. Each of the first cladding layer 922 and the second cladding layer 926 has a thickness of about 10 μm. These numbers are just a few non-limiting examples. One of ordinary skill in the art would recognize many variations, alternatives, and modifications. Alternatively, the waveguide 304 is a multimode waveguide. In that case, the core layer 924 has a thickness that is greater than 0.5 μm, for example, 10 μm, 20 μm, 30 μm, or the like.

The pixel structure 901 further includes a first conductive layer 942 disposed over the waveguide 304, an electro-optic polymer (EOP) layer 944 disposed over the first conductive layer 942, and a second conductive layer 946 disposed over the EOP layer 944. The first conductive layer 942 and the second conductive layer 946 may comprise indium tin oxide (ITO), graphene, or other suitable transparent conductive materials. An electric field may be applied to the EOP layer 944 by applying a bias voltage between the first conductive layer 942 and the second conductive layer 946.

EOP materials exhibit the Pockels effect, in which change in the refractive index is linearly proportional to the applied electric field. EO polymers have relatively large EO coefficients compared to inorganic EO materials. For example, EO polymers typically have 6 to 10 times as much EO effect as lithium niobate (LiNbO₃). One class of EOP materials includes certain types of liquid crystal polymers that exhibit EO effect. Liquid crystal EO polymers may have an EO coefficient that is as much as 300 picometers per volt. According to an embodiment, a method of forming the EOP layer 944 includes forming a pixel-defining layer 960. The pixel-defining layer 960 defines a plurality of pockets, each pocket corresponding to a pixel (or a sub-pixel). The method further includes filling each pocket with liquid crystal EO polymers. In a roll-to-roll processing, a shower head may be used to fill the pockets with liquid crystal EO polymers. Then a sealing film is laid on top of that. The sealing film squeezes out the excess liquid crystal EO polymer that is outside the pockets and traps the liquid crystal EO polymer that is inside the pockets.

Another class of EO polymers includes a poly(methyl methacrylate) (PMMA) polymer matrix doped with organic nonlinear chromophores, fluorinated polymer matrix doped with organic nonlinear chromophores, and the like. A fluorinated polymer matrix has the added advantage that it provides a moisture barrier, as SiO₂ is vulnerable to moisture. A PMMA polymer matrix doped with organic nonlinear chromophores or a fluorinated polymer matrix doped with organic nonlinear chromophores may have an EO coefficient that is as much as 200 picometers per volt. The chromophores need to be poled in order for the material to change its refractive index under an applied voltage. This means that the chromophore molecules have to be aligned in the same direction. In some manufacturing processes, the EO polymers are heated and a high voltage is applied for initial alignment. Then in this process, the polymers are cooled down and the voltage is turned off, so that the orientation of the molecules is fixed and the material is ready for operation.

According to embodiments of the present invention, the pixel structure includes a controller operable to adjust the bias voltage applied between the first conductive layer 942 and the second conductive layer 946, thereby varying the refractive index of the EOP layer 944. When the refractive index of the EOP layer 944 is less than the second refractive index of the second cladding layer 926, no part of the evanescent light wave in the second cladding layer 926 is transmitted into the EOP layer 944. This may be referred to as the “OFF” state of the EOP layer 944. Conversely, when the refractive index of the EOP layer 944 is greater than the second refractive index of the second cladding layer 926, a portion of the evanescent light wave in the second cladding layer 926 is transmitted into the EOP layer 944. This may be referred to as the “ON” state of the EOP layer 944. The amount of light that is transmitted into the EOP layer 944 may be varied by varying the refractive index of the EOP layer 944 in the “ON” state. In general, the amount of light that is transmitted into the EOP layer 944 increases with increasing value of the refractive index of the EOP layer 944. According to some embodiments, the refractive index of the EOP layer 944 may be varied in the range from about 1.55 to about 1.85 in the “ON” state.

According to an embodiment, the pixel structure further includes a diffuser layer 980 disposed over the second conductive layer 946. The light transmitted into the EOP layer 944 generally propagates in the direction parallel to the plane of the EOP layer 944. The diffuser layer 980 converts the light transmitted into the EOP layer 944 into a Lambertian emission from the surface of the diffuser layer 980. The diffuser layer 980 may be a bead-filled diffuser, a film with light scattering particles dispersed therein, a film with a matte surface, a film with micro-lens geometries on its surface, or any other types of diffuser used in the art.

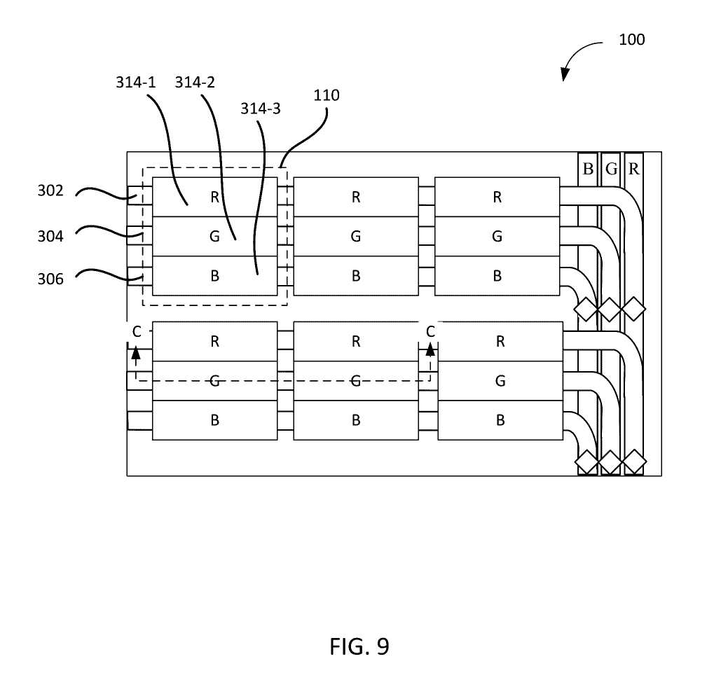

FIG. 11 illustrates a schematic cross sectional view of a pixel structure of a display device according to another embodiment of the invention. The EOP layer 944 includes a plurality of scattering centers 948 dispersed therein. The scattering centers 948 scatter the light transmitted into the EOP layer 944 and convert it into a Lambertian emission from the EOP layer 944. The scattering centers 948 may be microbeads or scattering particles. Scattering particles may comprise poly(acrylate), poly(alkyl methacrylate), poly (tetrafluoroethylene), silicone, zinc, antimony, titanium, barium, and the like, or oxides and sulfides thereof, or mixtures thereof.

According to an embodiment, the pixel structure further includes a transparent cover layer 316 over the second conductive layer 946. The cover layer 316 may extend over the entire surface of the display device 100, including the pixel defining layer 960. The cover layer 316 protects the pixel structure from contamination and physical damages.

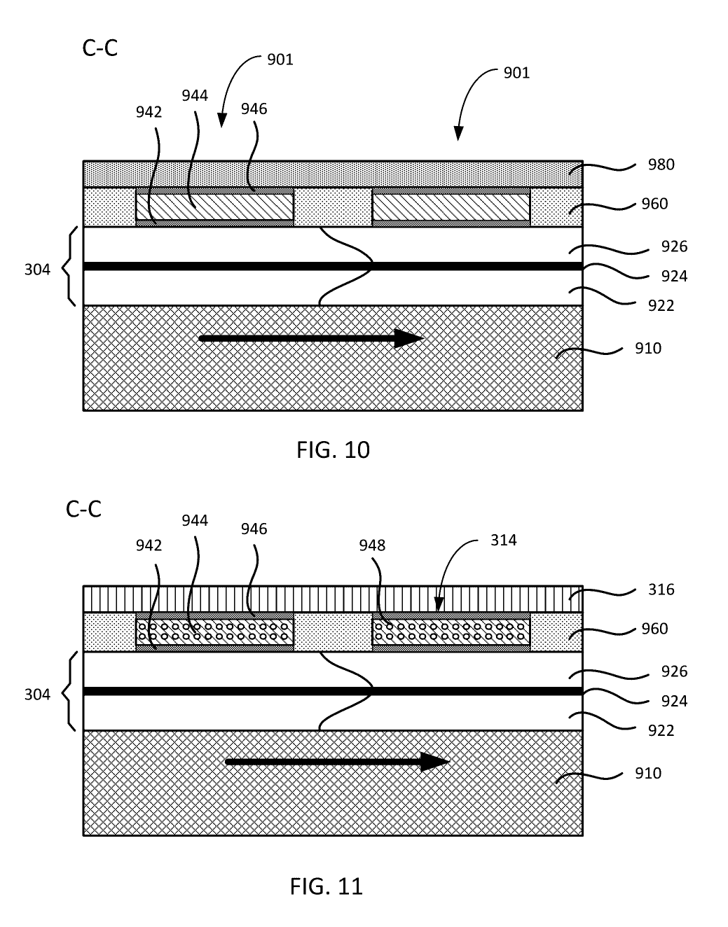

FIG. 12 illustrates a schematic cross sectional view of a pixel structure of a display device 100 according to an additional embodiment of the invention. The pixel structure further includes a grating structure 950 formed between the EOP layer 944 and the first conductive layer 942. The grating structure 950 is configured to gather and diffract the evanescent light wave in the second cladding layer 926 to form an output light directed substantially perpendicular to and away from the surface of the display device 100, as indicated schematically by the thin arrows in FIG. 12. According to an embodiment, the grating structure 950 may include periodic saw-tooth structures. The direction of the output light may be chosen by selecting an appropriate blazing angle of the saw-tooth structures.

In an embodiment, the grating structure 950 is formed in a PMMA polymer film doped with organic nonlinear chromophores, which is integrated with the EOP layer 944. The refractive index of the grating structure 950 in the “OFF” state may substantially match the refractive index of the second cladding layer 926, so as to reduce light scattering in the “OFF” state. When the grating structure 950 is turned to the “ON” state by increasing its refractive index, a significantly greater amount of light nay be coupled out of the pixel as compared to a pixel structure without the grating structure 950. As much as 90% of the evanescent light wave in the second cladding layer 926 may be coupled out of a pixel according to some embodiments.

According to an embodiment, the grating structure 950 is defined as a computer generated hologram (CHG). A holographic image can be generated by digitally computing a holographic interference pattern and printing it onto a film, for example, a PMMA polymer film, a fluorinated polymer film, and the like. The emission pattern is determined from the Fourier transform of the CHG. In an embodiment, the CHG is a chirped grating. One may engineer the directionality of the emission pattern by engineering the chirp in the chirped grating. For example, one may engineer the chirp so that the emission pattern has a flat top within the viewing angle and then drops off rapidly. That means a viewer of the display device can have privacy when viewing the display in proximity to other people, such as sitting in an airplane with people all around you. An emission pattern of arbitrary shape may be achieved by combining chirp and apodization.

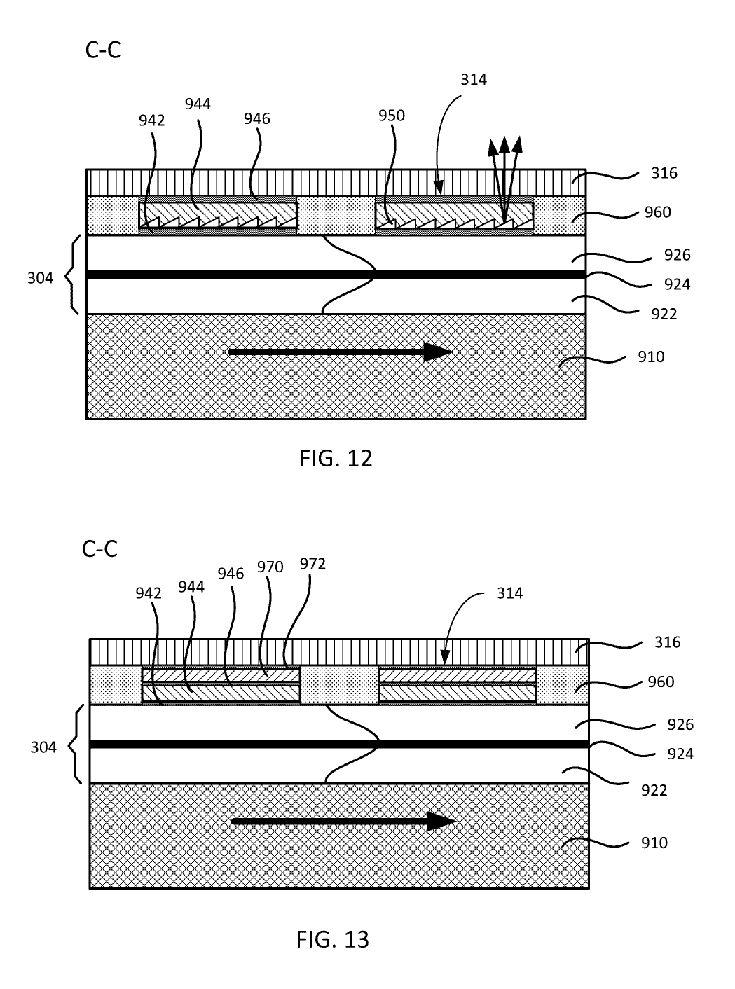

FIG. 13 illustrates a schematic cross sectional view of a pixel structure of a display device according to a specific embodiment of the invention. The pixel structure further includes a second EOP layer 970 over the second conductive layer 946, and a third conductive layer 972 over the second EOP layer 970. Because the second EOP layer 970 is not coupled to the waveguide 304, its refractive index no longer controls the amount of light coupled out of the pixel from the waveguide 304. Instead, its refractive index is varied to modulate the phase of the light coming out of the pixel. According to an embodiment, the controller is further operable to adjust a bias voltage applied between the second conductive layer 946 and the third conductive layer 972, thereby varying the refractive index of the second EOP layer 970. One may have an array of pixels that, in combination, emit a light wave with a wave front that has been created by setting the phase of each pixel on a pixel-by-pixel basis. A holographic display may be created in this manner.

According to an embodiment, the substrate 910 comprises a plastic material. The pixel structure described herein, including the waveguide 304, the pixel-defining layer 960, the EOP layer 944, and the cover layer 316, can be formed by a roll-to-roll process. The display device may have a rectangular shape, such as in a TV screen. Alternatively, the display device may have an irregular shape. For example, the display device may have a shape of a hand for displaying different sets of fingerprints. According to other embodiments, the substrate 910 comprises a ceramic material, such as aluminum nitride, beryllium oxide, and the like. A ceramic substrate may be able to handle a large amount of power. Such a pixel structure may be used in a single-chip projection engine that emits as much as kilowatts of light. According to some embodiments, the substrate 910 may be either planar or curved. Curved displays may be used in automobiles and/or in outdoor signage.

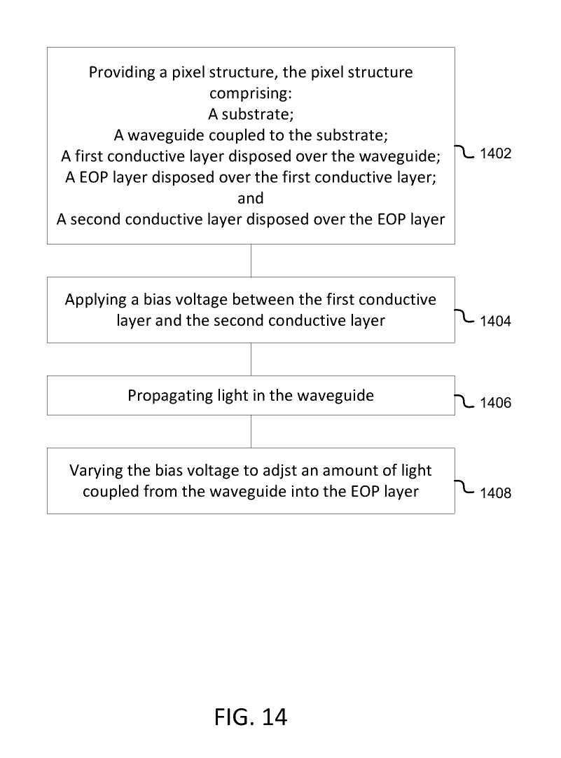

FIG. 14 shows a simplified flowchart illustrating a method of operating a pixel of a display device according to an embodiment of the invention. The method includes, at 1402, providing a pixel structure. The pixel structure 901 includes a substrate 910, a waveguide 304 coupled to the substrate 910, a first conductive layer 942 disposed over the waveguide 304, an EOP layer 944 disposed over the first conductive layer 942, and a second conductive layer 946 disposed over the EOP layer 944. The waveguide 304 includes a first cladding layer 922 disposed over the substrate 910, a core layer 924 disposed over the first cladding layer 922, and a second cladding layer 926 disposed over the core layer 924. The method further includes, at 1404, applying a bias voltage between the first conductive layer 942 and the second conductive layer 946; at 1406, propagating light in the waveguide 304; and at 1408, varying the bias voltage to adjust an amount of light coupled from the waveguide 304 into the EOP layer 944.

It should be appreciated that the specific steps illustrated in FIG. 14 provide a particular method of operating a pixel of a display device according to an embodiment. Other sequences of steps may also be performed according to alternative embodiments. For example, alternative embodiments may perform the steps outlined above in a different order. Moreover, the individual steps illustrated in FIG. 14 may include multiple sub-steps that may be performed in various sequences as appropriate to the individual step. Furthermore, additional steps may be added or removed. One of ordinary skill in the art would recognize many variations, modifications, and alternatives.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A pixel structure of a display device, the pixel structure comprising:
a substrate;
a waveguide coupled to the substrate, the waveguide comprising:
a first cladding layer disposed over the substrate;
a core layer disposed over the first cladding layer; and
a second cladding layer disposed over the core layer;
a first conductive layer disposed over the waveguide;
a first electro-optic polymer (EOP) layer disposed over the first conductive layer;
a second conductive layer disposed over the first EOP layer; and
a controller operable to adjust a first bias voltage applied between the first conductive layer and the second conductive layer;
wherein a first refractive index of the first EOP layer is varied in response to the first bias voltage, thereby adjusting an amount of light coupled into the first EOP layer from the waveguide.

2. The pixel structure of claim 1 wherein the substrate comprises a plastic polymer material.

3. The pixel structure of claim 1 wherein the substrate comprises a ceramic material.

4. The pixel structure of claim 1 wherein the first cladding layer and the second cladding layer comprise SiO₂ and the core layer comprises Si₃N₄.

5. The pixel structure of claim 1 wherein the waveguide comprises a single-mode waveguide.

6. The pixel structure of claim 1 wherein the first EOP layer comprises a liquid crystal polymer.

7. The pixel structure of claim 1 wherein the first EOP layer comprises chromophores dispersed in poly(methyl methacrylate) (PMMA).

8. The pixel structure of claim 1 further comprising a diffuser layer disposed over the second conductive layer, the diffuser layer configured to convert the amount of light coupled into the first EOP layer into a Lambertian emission of light from the diffuser layer.

9. The pixel structure of claim 1 further comprising a plurality of scattering centers dispersed in the first EOP layer, the plurality of scattering centers configured to convert the amount of light coupled into the first EOP layer into a Lambertian emission of light from the first EOP layer.

10. The pixel structure of claim 9 further comprising a cover layer disposed over the second conductive layer.

11. The pixel structure of claim 1 further comprising a grating structure formed between the first EOP layer and the first conductive layer.

12. The pixel structure of claim 11 wherein the grating structure comprises a computer generated hologram.

13. The pixel structure of claim 12 wherein the computer generated hologram comprises a chirped grating.

14. The pixel structure of claim 1 further comprising:
a second EOP layer disposed over the second conductive layer; and
a third conductive layer disposed over the second EOP layer;
wherein the controller is further operable to adjust a second bias voltage applied between the second conductive layer and the third conductive layer, and wherein a second refractive index of the second EOP layer is varied in response to the second bias voltage, thereby adjusting a phase of the amount of light coupled into the first EOP layer.

15. A method of operating a pixel of a display device, the method comprising:
providing a pixel structure comprising:
a substrate;
a waveguide coupled to the substrate, the waveguide comprising:
a first cladding layer disposed over the substrate;
a core layer disposed over the first cladding layer; and
a second cladding layer disposed over the core layer;
a first conductive layer disposed over the waveguide;
an electro-optic polymer (EOP) layer disposed over the first conductive layer; and
a second conductive layer disposed over the EOP layer;
applying a bias voltage between the first conductive layer and the second conductive layer;
propagating light in the waveguide; and
varying the bias voltage to adjust an amount of light coupled from the waveguide into the EOP layer.

16. The method of claim 15 wherein the substrate comprises a plastic polymer material.

17. The method of claim 15 wherein the substrate comprises a ceramic material.

18. The method of claim 15 wherein the first cladding layer and the second cladding layer of the waveguide comprises SiO₂, and the core slab of the waveguide comprises Si₃N₄.

19. The method of claim 15 wherein the waveguide comprises a single-mode waveguide.

20. The method of claim 15 wherein the EOP layer comprises a liquid crystal polymer.

21. The method of claim 15 wherein the EOP layer comprises a chromophores dispersed in poly(methyl methacrylate) (PMMA).
